(19) United States
(12) Patent Application Publication
(10) Pub. No.: US 2025/0299844 A1
(43) Pub. Date: Sep. 25, 2025

(54) UNIT FOR HANDLING A CONTAINER FOR THE PRODUCTION OF RADIOISOTOPES

(71) Applicant: COMECER S.P.A., Castel Bolognese (RA) (IT)

(72) Inventors: Alessandro Brunetti, Castel Bolognese (RA) (IT); Marco Testa, Castel Bolognese (RA) (IT)

(21) Appl. No.: 18/860,249

(22) PCT Filed: May 5, 2023
(86) PCT No.: PCT/IB2023/054682

§ 371 Date: Oct. 25, 2024

(30) Foreign Application Priority Data
May 6, 2022 (IT) 102022000009338

(51) Int. Cl. G21G 1/10; G21G 1/00; G21G 4/08

(52) U.S. Cl. CPC G21G 1/10; G21G 1/001; G21G 4/08

(57) ABSTRACT

A unit for handling a container for a solid target material having a support body and a lid screwed onto the support body and for dissolving the solid target material in the container, the unit comprising a shielded isolator and within it: a work surface having a transfer port for the container; an unscrewing and screwing station having a rotating support mounted on the work surface for supporting the container and rotating the support body and a gripping device for holding the lid while the rotating support rotates for unscrewing or screwing the lid; a dissolution station for feeding a dissolving solution in the container with the purpose of dissolving the solid target material; and a handling device for moving the container between the transfer port and the unscrewing and screwing station and between the latter and the dissolution station.

### CROSS-REFERENCE TO RELATED APPLICATIONS

This patent application is related to Italian Patent Application No. 102022000009338 filed on May 6, 2022, the entire disclosure of which is incorporated herein by reference.

### TECHNICAL FIELD

The present invention relates to a unit for handling a container for a solid target material and to a corresponding system for producing radioisotopes.

### BACKGROUND

In particular, the present invention is advantageously, but not exclusively, applied to radioisotope production systems which utilize a cyclotron for producing a radioisotope starting from a solid precursor material, also known as solid target material, in the form of a thin layer electroplated on a suitable metal support, to which the following description will explicitly refer without thereby losing generality.

To date, various types of radioisotopes for pharmaceutical use (radiopharmaceuticals) are obtained following the irradiation by means of a beam of protons (proton bombardment) of a solid target material typically having a metal origin.

The production process of a radioisotope starting from a solid target material substantially provides for the following steps: electroplating the solid target material on a metal support; irradiating the solid target material on the support by means of proton beam; dissolving the irradiated solid target material for obtaining a solution in which the radioisotope produced by the proton irradiation is present; and purifying the aforementioned solution for separating the radioisotope from the target material which did not react and from impurities. The aforementioned steps are carried out in relative processing stations and therefore the support comprising the solid target material has to be disposed in a container in order to be transported between various processing stations, for example from the irradiation station to the dissolution station.

A system for producing radioisotopes is known comprising at least one container for the solid target material, an irradiation station, which comprises a cyclotron for emitting a proton beam against the solid target material in the container, a handling unit for handling the container and chemically dissolving the solid target material present in the container, a purification module for feeding an acid solution to the aforementioned handling unit for dissolving the solid target material and for extracting the radioisotope from the solution produced by the dissolution, and a pneumatic system for bidirectionally transferring the container between the irradiation station and the handling unit.

The handling unit comprises a shielded isolator, commonly also called cell, within which the following are housed: a work surface having a transfer port for the container; a parking support for the container disposed on top of the work surface; a dissolution station, which comprises at least one centring support for the container disposed on the work surface and a respective movable dissolution head for being disposed on the container when the latter is on the centring support; and a movable gripping head for gripping the container and moving it between the transfer port, the parking support and the dissolution station.

The pneumatic system comprises a flexible duct, which connects the transfer port on the work surface in the shielded isolator to the irradiation station, a first vacuum generator, which is connected to the gripping head for performing the transfer of the container from the irradiation station to the transfer port, and a second vacuum generator, which is connected to the irradiation station for performing the transfer of the container from the transfer port to the irradiation station.

In use, a container containing the solid target material is manually placed by an operator on the parking support. The gripping device grips the container and shifts it into the transfer port. By means of the action of the second vacuum generator, the container is transferred to the irradiation station, where the solid target material inside the container is irradiated with the proton beam for producing the radioisotope. The irradiation also modifies the material of the container making it become radioactive.

At the end of the irradiation step, the container and the material contained therein emit a high level of radiations dangerous for the human body and thus the operator cannot manually manipulate the container. Therefore, the container is transferred, in an automated manner, to the transfer port in the shielded isolator and gripped by the gripping head when it emerges from the transfer port by means of the action of the first vacuum generator and is then positioned on a centring support of the dissolution station by means of a sequence of movements of the gripping head. In the dissolution station, the solid target material is dissolved thus obtaining a solution which comprises the radioisotope and such solution is transferred to the purification module.

In order to reduce the exposure of the operator to the radiations, the utilization of containers provided with a hermetically closed lid can be assumed. However, once the container with lid emerges from the transfer port in the shielded isolator, it cannot be immediately transferred into the dissolution station because the lid does not enable introducing the dissolving solution in the container. Therefore, it is necessary to temporarily transfer the container onto the parking support where it remains for the time necessary for the operator to take the lid off of the container, thus nullifying the advantages of the use of the lid during the remaining production cycle of the radioisotope, since the container just returned from the irradiation station emits a high level of radiations.

### SUMMARY

The object of the present invention is to provide a system for producing radioisotopes, and in particular a unit for handling a container for a solid target material, which are exempt from the above-described drawbacks and, simultaneously, is easy and cost-effective to produce.

In accordance with the present invention a unit for handling a container for a solid target material and for dissolving the solid target material present in the container, an apparatus comprising such container and such unit, and a system for producing radioisotopes are provided, according to what defined in the appended claims.

### BRIEF DESCRIPTION OF THE DRAWINGS

The present invention will now be described with reference to the accompanying drawings, which illustrate a non-limiting example embodiment thereof, wherein:

FIG. 1 illustrates an exploded axonometric view of a container for a solid target material utilized by a system for producing radioisotopes manufactured according to the principles of the present invention;

FIG. 2 illustrates the container of FIG. 1 according to a section view along a plane on which the longitudinal axis of the container 1 lies;

FIGS. 3 and 4 illustrate a detail of FIG. 2 during two different uses of the container;

FIG. 5 illustrates, according to a partially schematic axonometric view, the system for producing radioisotopes of the present invention;

FIG. 6 illustrates, according to an axonometric view, a rotating support of a handling unit of the container being part of the system of FIG. 5;

FIG. 7 illustrates, according to a section axonometric view along a vertical plane, a gripping device of a handling unit of the container being part of the system of FIG. 5, cooperating with the rotating support of FIG. 6; and

FIG. 8 illustrates, according to a section axonometric view along a further vertical plane, a part of the gripping device of FIG. 6.

### DESCRIPTION OF EMBODIMENTS

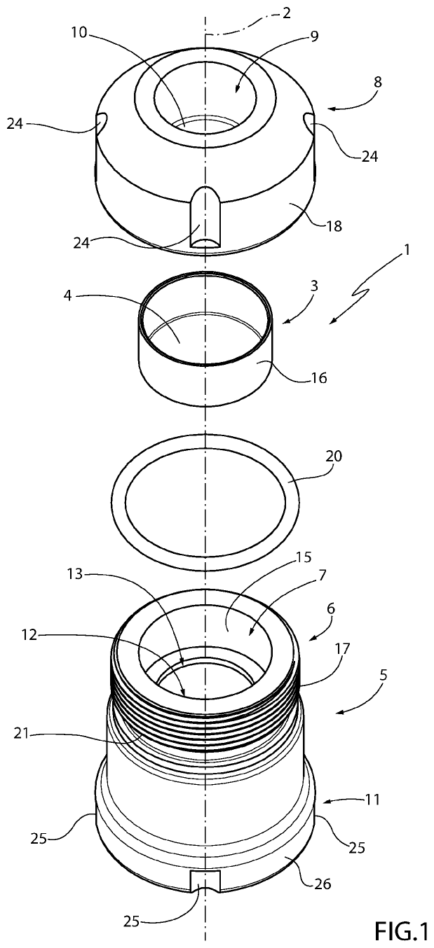

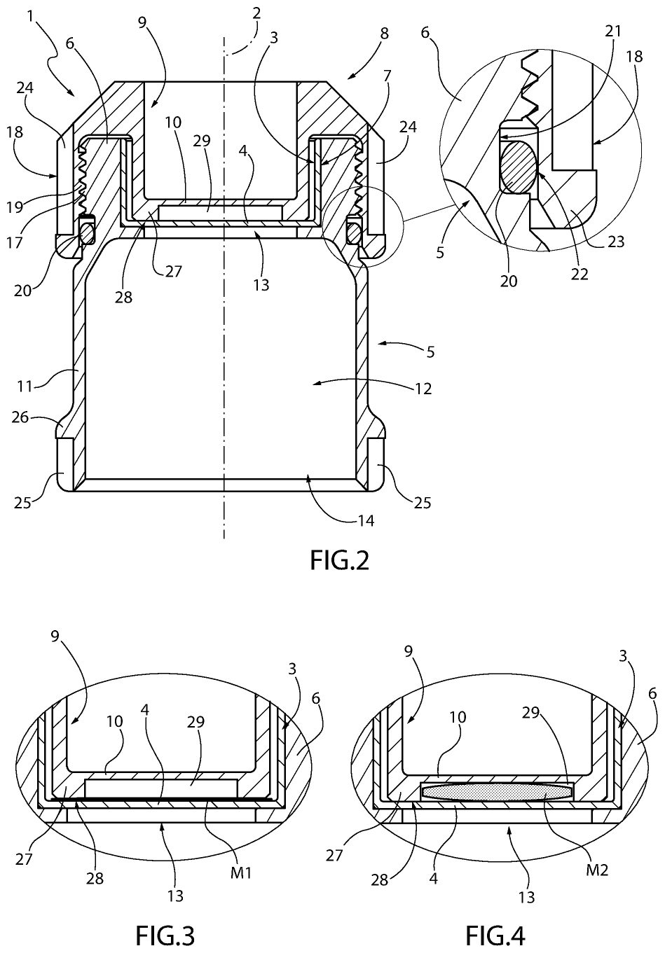

In FIGS. 1 and 2, reference numeral 1 generically indicates, as a whole, the container of the present invention suitable for containing a solid target material and a radioisotope produced by means of irradiation with proton beam of the solid target material.

The container 1 extends according to a longitudinal axis 2 thereof and comprises a well-shaped body 3, in the following simply called well, which is suitable for supporting on a bottom wall 4 thereof a portion of solid target material (not illustrated), a support body 5, which extends according to the longitudinal axis 2 and comprises a first portion 6 having a seat 7 suitable, in use, for coaxially housing the well 3 so that the bottom wall 4 is disposed transverse to the longitudinal axis 2, and a lid 8, which is fitted, and in particular screwed, on the support body 5.

More specifically, the lid 8 comprises a cup-shaped central portion 9, the bottom of which comprises a degrading foil 10 suitable for mitigating the proton beam in a pre-established manner. The lid 8 is suitable, in use, for being coaxially screwed onto the portion 6 so that the central portion 9 is disposed in the well 3 for holding the portion of solid target material on the bottom wall 4 and that the degrading foil 10 is disposed above, and in particular parallel to, the bottom wall 4 so that the portion of solid target material is disposed, in use, between the degrading foil 10 and the bottom wall 4.

In use, a proton beam (not illustrated in FIGS. 1 and 2) is directed on the central portion 9 in the direction of the longitudinal axis 2, and in particular centred on the longitudinal axis 2, for striking the degrading foil 10 in a substantially perpendicular manner. The degrading foil 10 has a thickness calibrated for mitigating the proton beam in such a measure to transfer to the portion of solid target material disposed in the well 3 a medium energy (MeV) which allows obtaining the desired radioisotope. For example, the thickness of the degrading foil 10 is comprised between 50 μm and 500 μm. The value of the thickness is chosen according to the radioisotope to be produced. In particular, each radioisotope to be produced is associated with a respective lid 8 having a degrading foil 10 with a specific thickness which is sized according to the radioisotope.

The support body 5 has a shape of cylindrical symmetry with respect to the longitudinal axis 2. The well 3 has a shape of cylindrical cup, i.e. a cylinder without a base. Also the lid 8 has a shape of cylindrical symmetry.

The support body 5 comprises a second portion 11, which is coaxial to the portion 6. The portion 11 comprises an inner cavity 12, which communicates with the seat 7 through a first opening 13 transverse, and in particular coaxial, to the longitudinal axis 2 and with the outside through a second opening 14 (FIG. 2) transverse, and in particular coaxial, to the longitudinal axis 2 for allowing the access of a cooling fluid in the cavity 12. As is evident in FIG. 2, the bottom wall 4 of the well 3 closes the opening 13 when the well 3 is in the seat 7 so that the bottom wall 4, in use, is lapped by the cooling fluid. The cavity 12 has a shape of cylindrical symmetry with respect to the longitudinal axis 2.

The seat 7 houses the well 3 with hermetic interference between a side inner surface 15 (FIG. 1) of the seat 7 and a side external surface 16 (FIG. 1) of the well 3. Such hermetic interference is obtained with a precise machining of the side inner surface 15 and of the side external surface 16. The side hermetic interference between seat 7 and well 3 prevents, in use, the cooling fluid from passing through the opening 13 and ending up in the well 3.

The portion 6 of the support body 5 comprises an external thread 17 and the lid 8 comprises an annular portion 18, which is disposed around, in a coaxial manner, the central portion 9 and comprises an inner thread 19 (FIG. 2) for being screwed to the portion 6.

The container 1 further comprises a hermetic sealing ring 20, which is fitted on the support body 5. In particular, the hermetic sealing ring 20 is held in a groove 21 of the support body 5 disposed between the portion 6 and the portion 11. With particular reference to the enlarged detail of FIG. 2, the hermetic sealing ring 20 enters into contact with the support body 5, and in particular with the groove 21, and an inner surface 22 of an end portion 23 of the annular portion 18 of the lid 8 when the annular portion 18 is screwed to the portion 6. In this manner, the lid 8 hermetically seals the well 3 for preventing radioactive substances from coming out of the well 3 during the production of the radioisotope.

The lid 8 comprises one or more external notches 24 and similarly the portion 11 of the support body 5 comprises one or more external notches 25 for facilitating the gripping of a device which will be described in the following of the present document and has the purpose of screwing and unscrewing the lid 8. In particular, the notches 25 are disposed along an end portion 26 of the portion 11 which surrounds the opening 14.

The support body 4 and the lid 8 are made of aluminium, which is an easily workable metal. The well is made of a material suitable for electroplating the solid target material and is inert to acid substances capable of dissolving the portion of solid target material. Preferably, the well 3 is internally made of platinum. Advantageously, all the walls of the well 3 have a thickness less than 1 mm, in particular approximately 500 μm.

With particular reference to FIG. 2, the central portion 9 comprises an annular rib 27 surrounding the degrading foil 10 and projects from the plane of the degrading foil 10 parallel to the longitudinal axis 2 so as to end with an end surface 28, it too annular, suitable for pressing against the bottom wall 4 of the well 3 when the lid 8 is completely screwed onto the portion 6 so as to define, between the degrading foil 10 and the bottom wall 4, a chamber 29 centred on the longitudinal axis 2 for containing a portion of solid target material. The structure of the central portion 9 allows containing the solid target material in various sizes.

FIG. 3 more specifically illustrates a portion of the container 1 around the chamber 29 in a utilization example in which the portion of solid target material is in the form of metal foil, indicated by M1, which is spread on the bottom of the well 3, i.e. on the bottom wall 4. In use, the lid 8 is fitted on the portion 6 and the annular portion 18 is screwed onto the portion 6 until the end surface 28 of the rib 27 presses an edge of the metal foil M1 against the bottom wall 4. The portion of metal foil M1 facing within the chamber 29 will be the one irradiated by the proton beam passing through the degrading foil 10.

FIG. 4 illustrates the same portion of the container 1 of FIG. 3 in a different utilization example in which the portion of solid target material is in the form of a capsule of compressed powder, indicated by M2, which is housed in the chamber 29. In use, the lid 8 is fitted on the portion 6 and the annular portion 18 is screwed onto the portion 6 until the end surface 28 of the rib 27 enters into contact with the bottom wall 4. In this manner, the capsule of compressed powder M2 is held by the chamber 29 and in centred position on the longitudinal axis 2. The capsule of compressed powder M2 will thus be completely irradiated by the proton beam through the degrading foil 10.

In a further utilization example not illustrated, the portion of solid target material is in the form of a thin layer of material electroplated on the bottom wall 4 of the well 3 so as to remain within the chamber 29, i.e. completely underneath the degrading foil 10 so as to be irradiated by the proton beam which strikes the degrading foil 10.

In FIG. 5, reference numeral 30 generically indicates, as a whole, a system for producing radioisotopes. The radioisotope production system 30 comprises at least one container 1 for a solid target material, an irradiation station 31, which comprises a cyclotron 32 for emitting a proton beam against the solid target material in the container 1 with the purpose of obtaining the radioisotope, and a unit 33 for handling the container 1 and dissolving the solid target material present in the container 1 after the solid target material has been irradiated. Furthermore, the radioisotope production system 30 comprises a pneumatic transfer system 34 for bidirectionally transferring a container 1 between the irradiation station 31 and the unit 33.

The irradiation station 31 comprises a support and connection assembly 35, of known type and therefore schematically illustrated, for supporting the container 1 with the well 3 facing the cyclotron 32 and connecting the cavity 12 of the container 1 to a fluid cooling system, it too known and not illustrated, with the purpose of making a cooling fluid circulate in the cavity 12 for cooling the well 3 during the irradiation with the proton beam.

The unit 33 comprises a shielded isolator 36, which houses therein a work surface 37, a transfer port 38 for the container 1 obtained on the work surface 37, an unscrewing and screwing station 39 for unscrewing and screwing the lid 8 of the container 1, a dissolution station 40 for dissolving the solid target material in the container, and a handling device 41 for moving the container 1 between the transfer port 38 and the unscrewing and screwing station 39 and between the latter and the dissolution station 40. The transfer port 38 is disposed between the unscrewing and screwing station 39 and the dissolution station 40 along the work surface 37.

The transfer port 38 is used for sending the container 1 to the irradiation station 31 and for receiving the container 1 arriving from the irradiation station 31 and for such reason it cooperates with the pneumatic transfer system 34.

The unscrewing and screwing station 39 comprises a rotating support 42 mounted on the work surface 37 for supporting the container 1 and bringing the support body 5 into rotation around an axis 42a perpendicular to the work surface 37, and a gripping device 43 for holding the lid 8 while the rotating support 42 rotates so as to unscrew or screw the lid 8, depending on the direction of rotation around the axis 42a, and for holding the lid 8 after it has been unscrewed. FIG. 5 illustrates a container 1 on the rotating support 42.

The gripping device 43 comprises a gripping head 44 and a slide 45, which supports the gripping head 44 in a position coaxial to the rotating support 42, i.e. centred on the axis 42a, and is mounted on an inner wall 46 of the shielded isolator 36 perpendicular to the work surface 37 so as to be movable in a direction 47 perpendicular to the work surface 37 between a raised position, which is the situation illustrated by FIG. 5, in which the gripping head 44 is at a certain distance from the rotating support 42, and a lowered position, in which the gripping head 44 couples to the lid 8.

The dissolution station 40 comprises at least one centring support 48 fixed to the work surface 37 for supporting the container 1 and at least one respective dissolution head 49 for feeding a dissolving solution, and in particular a substantially acid solution, into the container 1 which is on the centring support 48 with the purpose of dissolving the solid target material.

In use, the container 2 is placed on the centring support 48 without the lid 8. The dissolution head 49 is mounted on a slide 50 movable parallel to the direction 47 so as to be disposed on the container 1 and couple to the well 3 when the container 1 is on the centring support 48, so that the dissolving solution is fed to the well 3.

The centring support 48 has an upper portion shaped for engaging the cavity 12 of the support body 5 of the container 1 through the opening 14. The centring support 48 can be electrically heated for facilitating the dissolution of some types of solid target materials.

The dissolution head 49 is also suitable for collecting the solution produced by the dissolution of the solid target material. The feeding of the dissolving solution to the container 1 and the collection of the solution produced by the container 1 occur when the dissolution head 49 is placed on the centring support 48.

In particular, the dissolution head 49 is connected by means of ducts (not illustrated) to a purification module, known per se and thus not illustrated. The purification module provides the dissolving solution to the dissolution head 49 and receives from the latter the solution produced by the dissolution of the solid target material with the purpose of purifying it and insulating the radioisotope, according to prior arts.

In the example embodiment illustrated by FIG. 5, the dissolution station 40 comprises a plurality of centring supports 48, in particular three centring supports 48, and an equal number of dissolution heads 49. A container 1 without lid 8 is illustrated on one of the centring supports 48. The dissolution heads 49 are movable in a mutually integral manner. The dissolution heads 49 are pre-configured to operate the dissolution of different solid target materials. In other words, the dissolution station 40 can operate on one container 1 at a time. For such purpose, the dissolution heads 49 are connected by means of ducts to respective solutions of the purification module.

The unit 33 comprises, still inside the shielded isolator 36, a parking support 51, which is fixed to the work surface 37 and has an upper portion shaped like a similar upper portion of the centring support 48. FIG. 1 illustrates another container 1 on the parking support 51. The handling device 41 is suitable for moving the container 1 between the dissolution station 40, the parking support 51 and the transfer port 38.

The handling device 41 comprises a gripping head 52 movable parallel to the direction 47 and along another direction 53 parallel to the work surface 37. More specifically, the handling device 41 comprises a slide 54, which is movable along a guide 55 parallel to the work surface 37, and in particular extending along the inner wall 46, and the gripping head 52 is mounted in a sliding manner on at least one guide 56 integral with the slide 54 and perpendicular to the work surface 37. The transfer port 38, the rotating support 42, the parking support 51 and the centring supports 48 are disposed aligned on the work surface 37 along a line parallel to the guide 56. In this manner, the gripping head 52 can transfer the container 1 from one to the other of such supports 42, 51, 48 with simple movements along the directions 47 and 53.

The transfer port 38 is disposed between the parking support 51 and a centring support 48. With the slide 45 in the raised position, the gripping head 44 of the gripping device 43 is at a distance from the rotating support 42 such to leave a space necessary for the passage and positioning of the gripping head 52 of the handling device 41 on the rotating support 42.

The unit 33 comprises, still inside the shielded isolator 36, a storehouse 57 for containers of the type of the container 1, disposed underneath the work surface 37 and communicating with the transfer port 38. The storehouse 57 comprises, therein, a drum or revolver (not illustrated), which rotates around an axis of rotation perpendicular to the work surface 37 and has a plurality of seats shaped for keeping respective containers standing and distributed in a uniform manner around the axis of rotation.

The storehouse 57 comprises an upper duct 58 for the connection with the transfer port 38. The upper duct 58 is necessarily disposed in the shielded isolator 36. The storehouse 57 comprises a lower duct 59 which protrudes on the outside of the shielded isolator 36 for the connection with the pneumatic transfer system 34.

The pneumatic transfer system 34 comprises a flexible duct 60 which connects the lower duct 59 with the irradiation station 31, and in particular with the support and connection assembly 35.

The pneumatic transfer system 34 further comprises a first vacuum generator 61, which is connected to the gripping head 52 for performing the transfer of the container 1 from the irradiation station 31 to the transfer port 38, and a second vacuum generator 62, which is connected to the support and connection assembly 35 for performing the transfer of the container 1 from the transfer port 38 to the irradiation station 31. In the example embodiment of FIG. 5, the vacuum generator 61 is disposed in the shielded isolator 36.

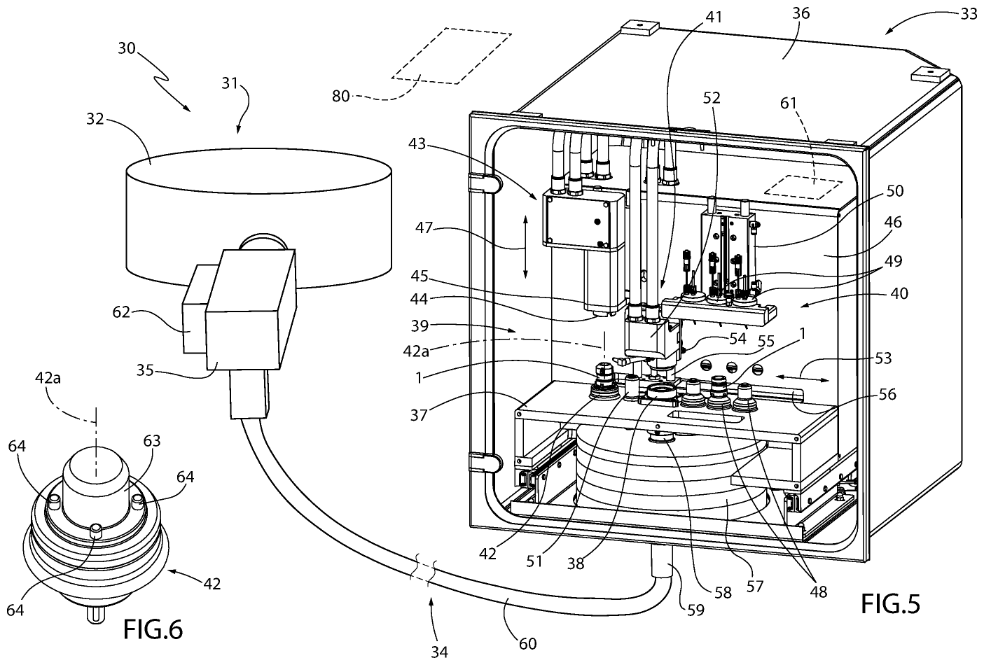

With reference to FIG. 6, the rotating support 42 comprises an upper portion 63, which is centred on the axis 42a and is shaped so as to engage the cavity 12 of the support body 5 of the container 1 through the opening 14, and one or more pins 64 disposed at the side of the upper portion 63 and parallel to the axis 42a, in particular distributed along an annular portion transverse to the axis 42a which surrounds the upper portion 63 so that, in use, each pin 64 couples to a relative notch 25 of the end portion 26 of the support body 5 of the container 1. The coupling between pins 64 and notches 25 has the purpose of holding the support body 5 during the rotation of the rotating support 42.

The unit 33 comprises an actuator (not illustrated), and in particular a gearmotor provided with an encoder, fixed under the work surface 37 for bringing the rotating support 42 into rotation.

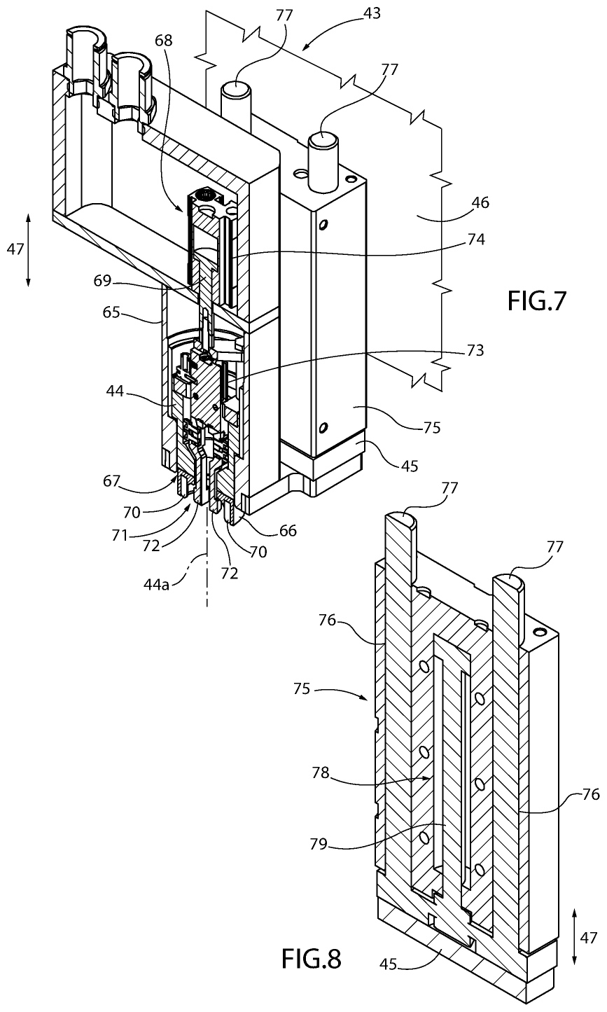

With reference to FIG. 7, which illustrates the gripping device 43 in section along a plane parallel to the inner wall 46 of the shielded isolator 36, the gripping head 44 is movably mounted on the slide 45 so as to translate parallel to the direction 47. In particular, the gripping device 43 comprises a box 65 integral with the slide 45 and the gripping head 44 is mounted in the box 65 so as to be movable with respect to the slide 45 along an axis 44a parallel to the direction 47 and has a gripping portion 66 which protrudes from a lower opening 67 of the box 65.

The gripping device 43 comprises a pneumatic cylinder 68, which is suitable for operating in thrust and is fixed inside the box 65, and the gripping head 44 is fixed to the piston 69 of the pneumatic cylinder 68 so that, in use, the latter presses the gripping head 44 on the lid 8 along the axis 44a when the slide 45 is in a lowered position. The pneumatic cylinder 68 comprises two pressure adjusting devices of manual type (not illustrated) for adjusting the thrust at a suitable value. In practice, the pneumatic cylinder 68 is used as a spring which works by compression.

The gripping head 44 comprises, at the gripping portion 66, one or more pins 70 parallel to the axis 44a and distributed so that each one of them, in use, couples to a relative notch 24 of the lid 8 of the container 1. The coupling between the pins 70 and the notches 24 has the purpose of holding the lid 8 in position in the gripping head 44. The gripping head 44 further comprises an expansion gripper 71, which is suitable for engaging the central portion 9 of the lid 8 when, in use, the pins 70 are coupled to the relative notches 24 for keeping the lid 8 gripped also when it is unscrewed and moved away from the container 1.

The expansion gripper 71 comprises two jaws 72 movable transverse to the axis 44a. The expansion gripper 71 is single-acting and normally open, i.e. with the jaws 72 drawn close to each other (as is illustrated in FIG. 7). The gripping device 43 comprises a solenoid valve (not illustrated) for controlling the closing of the expansion gripper 71, i.e. the mutual moving away of the jaws 72.

The gripping device 43 comprises a position sensor 73 combined with the expansion gripper 71, for example a reed sensor, for determining the open/closed state of the expansion gripper 71.

The gripping device 43 comprises a linear sensor 74, for example analogue, preferably integrated in the pneumatic cylinder 68, for measuring the lengthening of the pneumatic cylinder 68, i.e. how much the piston 69 comes out of the body of the pneumatic cylinder 68. More in general, the linear sensor 74 is suitable for detecting the lowering, i.e. the downward shifting, of the gripping head 44 with respect to the slide 45 along the axis 44a.

The gripping device 43 comprises a frame 73 fixed to the inner wall 46 of the shielded isolator 36 and the slide 45 is movably mounted on the frame 73.

With reference also to FIG. 8, which illustrates the frame 75 in section along a plane parallel to the inner wall 46, the frame 75 comprises two cylindrical guides 76 parallel to the direction 47 and the slide 45 comprises two rods 77 which slide along the guides 76. The gripping device 43 comprises another pneumatic cylinder 78, which is integrated in the frame 75 with its axis parallel to the direction 47, and the slide 45 is fixed to the piston 79 of the pneumatic cylinder 79. The gripping device 43 comprises two position sensors (not illustrated), for example two reed sensors, for detecting when the slide 45 is in a raised position and in a lowered position, respectively.

The combination of the information provided by the position sensor 73, from the linear sensor 74 and from the position sensors associated with the movement of the slide 45 allows establishing the situation of correct engagement of the pins 64 of the rotating support 42 and of the pins 70 of the gripping head 44 in the relative notches 25 of the support body 5 and, respectively, in the relative notches 24 of the lid 8 and thus when it is possible to drive the rotation of the rotating support 42.

In particular, when the slide 45 is in a lowered position and thus the gripping head 44 presses on the lid 8, and the pins 64 and 70 are coupled to the relative notches 25 and 24, the lengthening of the pneumatic cylinder 68 tends to a maximum value. Furthermore, when it is necessary to unscrew the lid 8, the slide 45 is moved towards the lowered position with the expansion gripper 71 initially open. On the contrary, when it is necessary to screw the lid 8, the latter is carried by the gripping head 44 and thus the slide 45 is moved towards the lowered position with the expansion gripper 71 initially closed. In the first case, the lid 8 is initially screwed and the lengthening of the pneumatic cylinder 68 assumes a first value, whereas in the second case, the lid 8 is initially unscrewed and the lengthening of the pneumatic cylinder 68 assumes a second value less than the first value. In order to select the direction of rotation of the rotating support 42, the information provided by the position sensor 73 is necessary.

The unit 33, or more in general, the radioisotope production system 30, comprises an electronic control unit, schematically illustrated in FIG. 5 and indicated by 80, configured to drive the rotation of the rotating support 42 and to select the direction of rotation according to the signals provided by the position sensor 73, by the linear sensor 74 and by the position sensors associated with the movement of the slide 45. In particular, the rotation is driven when the slide 45 is in a lowered position and the lengthening of the pneumatic cylinder 68, and thus the lowering of the gripping head 44 with respect to the slide 45, exceeds a certain threshold value. The selected direction of rotation is of unscrewing when the expansion gripper 71 is initially open, whereas it is of screwing when the expansion gripper 71 is initially closed.

The electronic control unit 80 is configured to synchronize the handling device 41 with the vacuum generators 61 and 62 for transferring a container 1 forwards and backwards between the irradiation station 31 and the transfer port 38 of the unit 33 and, inside the latter, for moving the container 1 through the various processing stations in the following order: unscrewing and screwing station 39 for unscrewing the lid 8, dissolution station 40 for dissolving the solid target material, again unscrewing and screwing station 39 for re-screwing the lid 8 and transfer port 38 for transferring the container 1 into the storehouse 57, where it remains for a pre-established decay time.

The electronic control unit 80 is configured to synchronize the various actuators of the unscrewing and screwing station 39 for moving the slide 45 in the lowered position, activating the rotation of the rotating support 42 when the pins 64 and 70 are engaged in the relative notches 25 and 24 for unscrewing the lid 8, activating the expansion gripper 71 for gripping the lid 8, and moving the slide 45 in the raised position. When the container 1 returns in the unscrewing and screwing station 39, the above-sequence is repeated with the difference of activating the rotation of the rotating support 42 for screwing the lid 8 and then deactivating the expansion gripper 71 for releasing the lid 8.

Although the above-described invention particularly refers to a very precise example embodiment, it is not to be considered limited to such example embodiment, falling within its scope all those variations, modifications or simplifications covered by the appended claims, such as for example:
the gripping device 43 comprises, instead of the pneumatic cylinder 68, a suitably calibrated spring; and
the expansion gripper 71 comprises, instead of the two jaws 72, an elastic cylindrical body which shortens longitudinally for expanding diametrically.

The unit 33 and the container 1 described above form an apparatus which, once integrated in a radioisotope production system 30 comprising a cyclotron 32, has the advantage of strongly reducing the exposure of the operator to the ionizing radiations emitted by the radioisotope, thanks to the presence of the lid 8 which hermetically closes the container during most of the steps of the production cycle, with the exception of course of the operations linked to the dissolution station 40 where it is strictly necessary to have the container 1 open, and to the unscrewing and screwing station 39 integrated in the operation of the unit 33.

Another advantage of the aforementioned apparatus and of the corresponding radioisotope production system 30 is the possibility to simplify the operativity of the irradiation station 31 for the production of different types of radioisotopes which require a different intensity of the proton beam, thanks to the lid 8 which comprises a degrading foil 10 having a specific thickness and which can thus be changed according to the desired radioisotope.

1. A unit for handling a container for a solid target material and for dissolving the solid target material present in the container, which comprises a support body (5) and a lid (8) screwed onto the support body (5); the unit (33) comprising a shielded isolator (36) and, within the latter: a work surface (37), which has a transfer port (38) for the container (1); an unscrewing and screwing station (39), which comprises a rotating support (42) mounted on the work surface (37) to support the container (1) and bring the support body (5) into rotation, and a gripping device (43) to hold the lid (8) while the rotating support (42) rotates so as to unscrew or screw the lid (8) and to keep the latter grasped after it has been unscrewed; a dissolution station (40), which comprises at least one fixed support (48) mounted on the work surface (37) for supporting the container (1) and at least one dissolution head (49) suitable for feeding a dissolving solution into the container (1) without the lid (8) to dissolve the solid target material; and a handling device (41) for moving the container (1) between the transfer port (38) and the unscrewing and screwing station (39) and between the latter and the dissolution station (40).

2. The unit according to claim 1, wherein said gripping device (43) comprises a gripping head (44) and a slide (45), which supports the gripping head (44) in a position coaxial to the rotating support (42) and is movable parallel to a direction (47) perpendicular to the work surface (37) to and from a lowered position, wherein the gripping head (44) couples, in use, to the lid (8).

3. The unit according to claim 2, wherein said lid (8) comprises a cup-shaped central portion (9) and at least one first external notch (24) and said gripping head (44) comprises at least one first pin (70), which is couplable to the first external notch (24) to hold the lid (8) in position in the gripping head (44), and an expansion gripper (71), which is suitable for engaging said central portion (9) when, in use, the first pin (70) is coupled to the first external notch (24) to grip the lid (8).

4. The unit according to claim 1, wherein said support body (5) comprises at least one second external notch (25) and said rotating support (42) comprises at least one second pin (64) couplable to the second external notch (25) to hold the support body (5) during the rotation of said rotating support (42).

5. The unit according to claim 4, wherein said support body (5) extends according to a longitudinal axis (2) and has an inner cavity (12) communicating with the outside through an opening (14) transverse to the longitudinal axis (2), and said at least one second external notch (25) is obtained in an end portion (26) of the support body (5) surrounding the opening (14); said rotating support (42) comprising an upper portion (63) shaped to engage the inner cavity (12) through the opening (14), and said at least one second pin (64) being disposed at the side of the upper portion (63).

6. The unit according to claim 2, wherein said gripping head (44) is movably mounted on the slide (45) by means of interposition of a pneumatic cylinder (28) or a spring operating in thrust to press, in use, the gripping head (44) on the lid (8) along an axis (44a) parallel to said direction (47) when the slide (45) is in said lowered position.

7. The unit according to claim 2, wherein said lid (8) comprises at least one first external notch (24), said support body (5) comprises at least one second external notch (25), said gripping head (44) comprises at least one first pin (70) couplable to the first external notch (24) to hold the lid (8) in position in the gripping head (44), said rotating support (42) comprises at least one second pin (64) couplable to the second external notch (25) for holding the support body (5) during the rotation of the rotating support (42), the gripping head (44) is movably mounted on the slide (45) to move along an axis (44a) parallel to said direction (47), and said gripping device (43) comprises a linear sensor (74) to detect the lowering of the gripping head (44) with respect to the slide (45) and at least one position sensor to detect when the slide (45) is in said lowered position; the amount of said lowering when the slide (45) is in the lowered position provides an indication of the correct engagement of the pins (70, 64) in the relative external notches (24, 25).

8. An apparatus comprising at least one container (1) for a solid target material and a unit (33) for handling the container (1) and dissolving the solid target material present in the container (1); said container (1) comprising a support body (5) and a lid (8) screwed onto the support body (5) and said unit (33) being according to claim 1.

9. The apparatus according to claim 8, wherein said gripping device (43) comprises a gripping head (44) and a slide (45), which supports the gripping head (44) in a position coaxial to the rotating support (42) and is movable parallel to a direction (47) perpendicular to the work surface (37) to and from a lowered position, wherein the gripping head (44) couples, in use, to the lid (8), said lid (8) comprises at least one first external notch (24), said support body (5) comprises at least one second external notch (25), said gripping head (44) comprises at least one first pin (70) couplable to the first external notch (24) to hold the lid (8) in position in the gripping head (44), said rotating support (42) comprises at least one second pin (64) couplable to the second external notch (25) for holding the support body (5) during the rotation of the rotating support (42), the gripping head (44) is movably mounted on the slide (45) to move along an axis (44a) parallel to said direction (47), and said gripping device (43) comprises a linear sensor (74) to detect the lowering of the gripping head (44) with respect to the slide (45) and at least one position sensor to detect when the slide (45) is in said lowered position; the amount of said lowering when the slide (45) is in the lowered position provides an indication of the correct engagement of the pins (70, 64) in the relative external notches (24, 25); said unit (33) comprises an electronic control unit (80) configured to drive the rotation of the rotating support (42) according to signals provided by said linear sensor (74) and said at least one position sensor.

10. A system for producing radioisotopes comprising the apparatus according to claim 8, an irradiation station (31) for emitting a proton beam against said solid target material in the container (1), and a pneumatic transfer system (34) for bidirectionally transferring the container (1) between the irradiation station (31) and said unit (33); said transfer port (38) being connected to the pneumatic transfer system (34).
